(19) United States
(12) Patent Application Publication
(10) Pub. No.: US 2023/0284788 A1
(43) Pub. Date: Sep. 14, 2023

(54) DISASSEMBLED BED BASE

(71) Applicant: ISTIKBAL MOBILYA SANAYI VE TIC. A. S., Melikgazi/Kayseri (TR)

(72) Inventor: Ibrahim KOKER, Melikgazi/Kayseri (TR)

(21) Appl. No.: 18/007,015

(22) PCT Filed: May 3, 2021
(86) PCT No.: PCT/TR2021/050420

§ 371 Date: Jan. 26, 2023

(30) Foreign Application Priority Data
Jul. 28, 2020 (TR) 2020-12015

(51) Int. Cl. A47C 19/00

(52) U.S. Cl. CPC A47C 19/005

(57) ABSTRACT

The bed base has ease of assembly and can be manufactured and delivered in a disassembled configuration.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a disassembled bed base used in the furniture industry.

### 2. Description of Related Art Including Information Disclosed Under 37 CFR 1.97 and 37 CFR 1.98

Bedrooms, being one of the first designed parts of the home, may have various characteristics. Materials and designs used in bedrooms have great importance. Bed bases are an indispensable part of the bedrooms. Nowadays, individuals prefer products that do not occupy space in terms of volume, provide ease of assembly and delivery opportunities when purchasing modern or classic style furniture of their preference.

As is, the known technical status of bed bases featuring either wooden or metal construction are manufactured in a monoblock body and these bed bases usually occupy a lot of space in terms of volume and in addition have a heavy structure.

The technique, as usually applied in the known systems, consists of welding together the parts of the whole into a monoblock body. Consequently, this causes elevated freight and weight value parameters. The accessories (e.g., legs, concealed legs, etc.) to be attached to the available structure as well as the fabrics to be upholstered and the materials (wooden lathes, medium density fiberboards (MDF), particle boards, fittings, and fasteners, etc.) required for the upholstery of these fabrics are consumed in high quantities.

### BRIEF SUMMARY OF THE INVENTION

The present invention relates to a disassembled bed base developed to overcome the aforementioned disadvantages and introduce further novel advantages into the relevant technical field.

The present invention relates to a bed base that provides ease of assembly and that can be manufactured and delivered in a disassembled configuration.

Amongst the advantages of the said disassembled bed base are;

Able to be manufactured in disassembled configuration;

Able to be shipped and delivered in disassembled configuration;

Having a disassembled configuration instead of a welded, monoblock piece, thereby reducing the space occupied in terms of volume;

Featuring decreased freight and weight parameters, and

Eliminating the excess use of fabrics to be upholstered as well as the quantities of materials necessary for the fabrics to be used thereon.

The product obtained by means of the present invention is assembled and used easily anywhere and anytime by means of simple fittings without requiring assistance from technical service.

As the inventive product occupies less space volume-wise and is lightweight, it may be disassembled easily when a user desires to make additional room in the living space.

### BRIEF DESCRIPTION OF THE SEVERAL VIEWS OF THE DRAWINGS

Exemplary applications of the present invention which is briefly summarized above and will be disclosed in detail below, shown in the attached figures are provided only for illustrative purposes and demonstrate only some of the examples and/or applications of the present invention according to one or a plurality of embodiments. Said figures are provided only to provide a better understanding of the present invention, and therefore cannot be considered as limitations imposed on the scope and the applicability of the present invention. It should be noted that said figures are not necessarily scaled in order to ensure clarity and ease of illustration.

FIG. 1 illustrates the perspective view of the frame of the invention disassembled bed base.

FIG. 2 illustrates the perspective view of the invention disassembled bed base, wherein a fastener, particle board, and interfacing are installed thereto.

FIG. 3 illustrates a perspective view of a plywood fish joint piece attached to the invention disassembled bed base.

FIG. 4 illustrates the bolt and L-shaped fish joint piece of the invention disassembled bed base.

### DESCRIPTION OF THE DETAILS IN FIGURES

1—Vertical Sheet Metal Profile
2—Horizontal Sheet Metal Profile
3—Inner Sheet Metal Profile
4—Concealed Plastic Leg
6—Bolt
7—L-Shaped Fish Joint Piece
8—Metal Construction
9—Metal Fittings
13—Plywood Lathe
14—Fastener
15—Composition Board
16—Fiberboard
17—Particle Board
18—Interfacing

### DETAILED DESCRIPTION OF THE INVENTION

In this detailed description provided herein, preferred alternatives of the invention disassembled bed base are described only to provide a better understanding of the subject and without creating any limiting effect.

The present invention relates to a disassembled bed base that can be manufactured and delivered in disassembled configuration, that can be easily assembled and installed and that occupies less space in terms of volume.

A disassembled bed base, characterized in that, it comprises the components of; vertical sheet metal profile (1), horizontal sheet metal profile (2), inner sheet metal profile (3), concealed plastic leg (4), bolt (6), and L-shaped fish joint piece (7), and metal fittings (9).

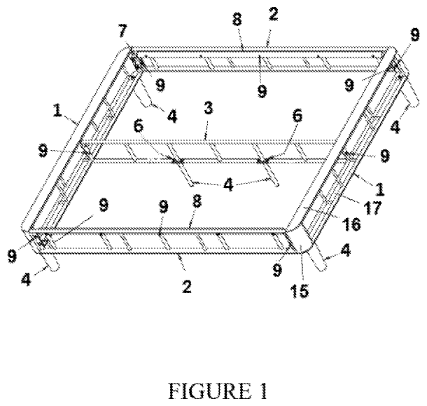

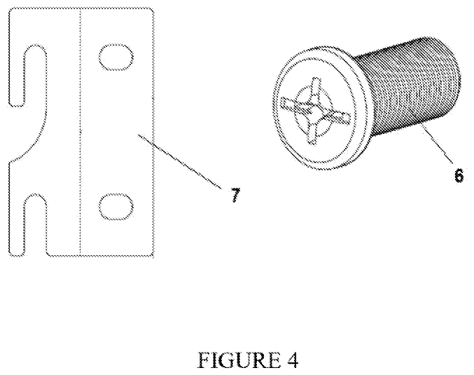

As illustrated in FIG. 1, the inventive disassembled bed base is assembled by welding the vertical sheet metal profile (1), horizontal sheet metal profile (2), and inner sheet metal profile (3) to each other. Said bolt (6), L-shaped fish joint piece (7), and metal fittings (9) are components that can be assembled together. Thus, metal fittings (9) are attached to one another by means of the bolt (6) and L-shaped fish joint piece (7). FIG. 4 illustrates said bolt (6) and the L-shaped fish joint piece (7).

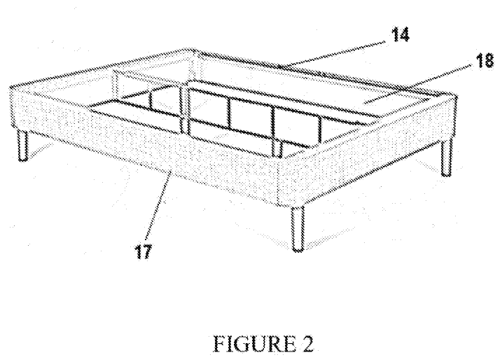

As shown in FIG. 1 and FIG. 2, wooden components like composition board (15), fiberboard (16), and particle board (17) are used in the structure in order to enable the frame of the invention disassembled bed base to be upholstered with fabric.

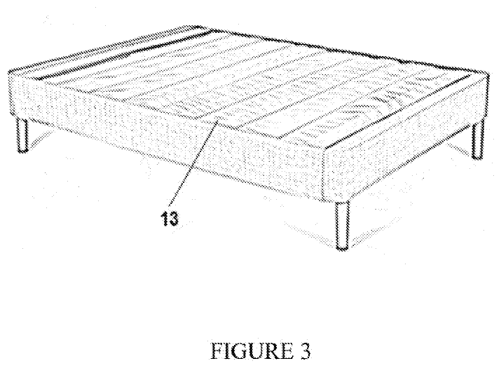

As illustrated in FIG. 3, plywood lathe (13), which is inserted into an interfacing (18) is used in order to place a mattress on the frame of the inventive disassembled bed base. Male-female fastener (14) is used in order to prevent the plywood lathe (13) from bending and making noise due to its structure. Plywood lathes (13) inserted into interfacing (18) are positioned onto the inventive disassembled bed base by means of the sheet metal profiles (1, 2, 3). Sheet metal profiles (1, 2, 3) are positioned on the plywood laths (13) inserted into interfacing (18).

In the invention disassembled bed base, the vertical sheet metal profile (1) is preferably selected such that it features a height of 5.5 cm, 15 cm, 161 cm, 151 cm, and a thickness of 10×10×1 mm. Preferably the horizontal sheet metal profile (2) is selected with a height of 187 cm, 5.5 cm, 161 cm, 151 cm, and a thickness of 10×20 0.9 mm. In the invention disassembled bed base, it is further preferred that the inner sheet metal profile (3) is selected such that it has a height of 187 cm and a thickness of 20×200.9 mm. Concealed plastic leg (4) used in the invention disassembled bed base is preferably selected so as to have a height of 178 cm and a thickness of 20×250.9 mm.

As the frame structure of the invention disassembled bed base is illustrated in FIG. 1, at least two vertical sheet metal profiles (1) with a thickness of 10×10×1 mm are positioned into the vertical section of the frame; at least two horizontal sheet metal profiles (2) with a thickness of 10×20 0.9 mm are positioned into the horizontal section of the frame, and at least one inner sheet metal profile (3) with a thickness of 20×200.9 mm is positioned into the inner section of the frame.

The invention disassembled bed base preferably has a volume of 0.116 m3 and a weight of 25.2 kg. Thus, the invention disassembled bed base offers significant advantages in terms of delivery and assembly.

The invention disassembled bed base is lightweight as it consists of wooden, metal, and plastic materials.

1. A disassembled bed base, comprising:
vertical sheet metal profile;
horizontal sheet metal profile;
inner sheet metal profile;
concealed plastic leg;
bolt;
L-shaped fish joint piece; and
metal fittings.

2. The disassembled bed base, according to claim 1, wherein the metal fittings are attached to one another by means of bolt and L-shaped fish joint piece.

3. The disassembled bed base, according to claim 1, further comprising: wooden components being comprised of a composition board, fiberboard, and particle board in the structure in order to enable the frame to be upholstered with fabric.

4. The disassembled bed base, according to claim 1, further comprising: a plywood lathe inserted into an interfacing so as to allow for placing a mattress on the frame structure.

5. The disassembled bed base, according to claim 4, further comprising: a female-male fastener in order to prevent the plywood lathe from bending and making noise due to its structure.

6. The disassembled bed base, according to claim 1, further comprising: sheet metal profiles that are positioned on plywood lathes inserted into an interfacing.

7. The disassembled bed base, according to claim 1, further comprising: at least two vertical sheet metal profiles with a thickness of 10×10×1 mm positioned into the vertical section of the frame structure.

8. The disassembled bed base, according to claim 1, further comprising: at least two horizontal sheet metal profiles with a thickness of 10×200.9 mm positioned into the horizontal section of the frame structure.

9. The disassembled bed base, according to claim 1, further comprising: at least one inner sheet metal profile with a thickness of 20×20 0.9 mm positioned into the inner section of the frame structure.

10. The disassembled bed base, according to claim 1, being comprised of wooden, metal, and plastic materials.
